(19) United States
(12) Patent Application Publication
(10) Pub. No.: US 2013/0088772 A1
(43) Pub. Date: Apr. 11, 2013

(54) System and Method of Applying Infrared Dye on Sunglasses and Other Lenses

(71) Applicant: Roger Wei-Yi Hsu, Rancho Cucamonga, CA (US)

(72) Inventor: Roger Wei-Yi Hsu, Rancho Cucamonga, CA (US)

(21) Appl. No.: 13/350,822

(22) Filed: Jan. 16, 2012

Related U.S. Application Data
(60) Provisional application No. 61/544,249, filed on Oct. 6, 2011.

(51) Int. Cl. G02B 5/30; B32B 27/00; B05D 5/06

(52) U.S. Cl. 359/352; 427/164; 428/500

(57) ABSTRACT

Methods of making eyeglasses lens are disclosed where the layers of the lenses include an infrared dye absorbed coating layer to provide an additional layer of protection against infrared, wherein the said coating decreases damage to the retina and cornea, improves contrast of color, increases visibility, and improves aesthetics of the lens.

### INCORPORATION BY REFERENCE

This application claims the benefit of priority under 35 U.S.C. 119(e) to the filing date of U.S. provisional patent application No. 61/544,249 “A Novel Method to Apply IR (infrared) Dye on Sunglasses and Other Lenses” which was filed on Oct. 6, 2011, and which is incorporated herein by reference in its entirety.

### FIELD OF THE INVENTION

The present invention generally relates to eyewear, and more particularly to the infrared coated lenses for glasses and a method of applying infrared coating of lenses.

### BACKGROUND OF THE INVENTION

Sunglasses are a form of protective eyewear designed primarily to prevent bright sunlight, ultraviolet radiation, and high-energy invisible light such as infrared from damaging the eyes. Infrared rays, in particular, are of concern, as much of the energy from the Sun arrives on Earth in the form of infrared radiation. Infrared is electromagnetic radiation that is commonly known as “heat radiation” or “heat ray” as it accounts for almost half of the heating of the Earth.

When exposed to intense sunlight for a lengthy period of time without protection, human eyes may experience a burning or stinging sensation that is often accompanied by fatigue. Such discomfort can be especially noticeable for those wearing contact lenses, as the infrared can be absorbed by the contact lenses causing them to “warm up”.

Once the infrared of the Sun goes through the lenses, it could also be absorbed by the cornea and reach the retina. The resulting heat from the infrared could cause burns, permanent scarring, and even some vision loss. Furthermore, prolonged exposure to sunlight or light emitting source can cause cataracts and even damage the Macula lutea. At a minimum, prolong exposure to such light could greatly reduce the eye sight of the viewers. As a result, protective layers such as infrared coating has been developed and applied to lens as a method of protecting the eye from injury caused by prolonged exposure to these lights.

The infrared coating of a lens is the application of an infrared dye absorbed coating onto the lens as a protective layer. The infrared absorbed coating can reduce the heat from the Sun or other light source, block red light to increase the contrast, and improve color discrimination. The reduction of heat from the Sun or other light source can reduce the absorption of such heat by the cornea or the retina, resulting in less discomfort and fatigue and prevent potential burning, scaring, or vision loss. The blockage of red light would greatly increase the contrast and result in sharper vision. The improvement of color discrimination would allow the viewer to see the world more vibrantly. Moreover, the infrared dye absorbed coating can also reduce radiation and glare, thus helping viewers see through foggy and hazy conditions. The reduction of radiation penetrating through the lenses would result in less infrared being absorbed by the cornea and reaching the retina, thus resulting in less damage to the cornea and retina. The infrared dye absorbed coating can also reduce glare to enhance the visions of the viewer, and enhance the visibility of the viewer allowing the viewer to see through foggy and hazy conditions, which may be especially dangerous conditions on the road.

Traditional methods of application of infrared dye onto lenses include the use of injection or extrusion of infrared dye onto the lenses. The high heat required in such traditional methods often degrades the integrity of the infrared dyes, and as a result reduces its effectiveness. Additionally, because the majority of lenses are curved, the curvature of the lenses presents a significant obstacle in the application of the infrared dye absorbed coating, as the application of the coating may be uneven. The uneven application of the infrared dye absorbed coating via injection or extrusion methods on a curved surface would reduce the effectiveness of the infrared blockage, thus defeating the said coating's original purpose. Furthermore, traditional coating methods by injection or extrusion methods are aesthetically less appealing because infrared dye appears green in such a coating. In order to counteract or offset the undesirable green color, gray colors may be added to the PVA film. The addition of such gray colors, however, reduces the penetration of light, and therefore the visibility of the viewers, significantly. Finally, the addition of the gray colors to the PVA films on the lens results in higher costs for the lenses, and thus higher costs for the end products.

The present invention provides methods of making lenses with an infrared dye absorbed coating, which avoids the problems associated with current method of preparing lenses, and to provide a lens with infrared dye absorbed coating made by said method.

### OBJECTIVE OF THE INVENTION

Accordingly, it is an objective of the invention to provide infrared dye absorbed coating layer for lenses.

It is an objective of the present invention to provide a method for making infrared dye absorbed coating for lenses.

It is an objective of the present invention to provide an infrared coating that is thinner than that of traditional infrared coating method for lenses.

It is an objective of the present invention to provide a method of infrared dye absorbed coating layer application whereby the infrared coating can be applied by dipping or spraying, among other techniques.

It is an objective of the present invention to provide a method to apply infrared dye absorbed coating layer to both plane/flat surfaces and on curved surfaces or uneven surfaces, such as for pad print, curved lenses, or silk screens, etc.

It is an objective of the present invention to provide a method of controlling the degree of infrared blockage via change in the amount of infrared dye powder in the solvent, whereby additional infrared dye powder can be added to increase the amount of infrared ray blocked of the coating and vice versa.

It is an objective of the present invention to provide a method of making an infrared dye absorbed coating with increased capability to block infrared.

It is an objective of the present invention to provide a method of making an infrared dye absorbed coating layer, wherein the said coating layer is aesthetically pleasing and does not distort the color of the coated lens.

It is an objective of the present invention to provide a method of making an infrared dye absorbed coating, wherein a wider range of wave lengths can be blocked with the same coating layer.

It is an objective of the present invention to provide a method of making an infrared dye absorbed coating, wherein the coating allows for better light transmission thus providing better visibility.

It is an objective of the present invention to provide a method of making an infrared dye absorbed coating that corrects the problem of traditional methods of coating including extrusion or injection, and avoids the method of using multi-layer vacuum coating.

It is another objective of the present invention to provide a method of making an infrared dye absorbed coating, wherein different IR dye absorbed powder can block different wave length and the different IR dye absorbed powder can be mixed to block a wider range of wave length.

### SUMMARY OF THE INVENTION

A method of making infrared dye absorbed PVA film is disclosed comprising: provide a first PVA film: dissolve the PVA film in a portion of water to make a portion of dissolved PVA film liquid; provide a portion of infrared dye powder; dissolve the portion of infrared dye powder in the portion of PVA film liquid to make a portion of infrared dye liquid; provide a second PVA film and apply the portion of infrared dye liquid to the second PVA film to make an infrared dye PVA film.

In one embodiment, the infrared dye liquid is applied to the second PVA film by dipping the second PVA film into a tank holding the infrared dye liquid. In another embodiment, the infrared dye liquid is applied to the second PVA film by spraying the infrared dye liquid onto the second PVA film. In yet another embodiment, the infrared dye liquid is applied to the second PVA film in room temperature.

In another aspect of the invention, the method of making polarized lens is disclosed comprising provide a first PVA film, dissolve the PVA film in a portion of water to make a portion of dissolved PVA film liquid; provide a portion of infrared dye powder; dissolve the portion of infrared dye powder in the portion of PVA film liquid to make a portion of infrared dye liquid; provide a second PVA film; apply the portion of infrared dye liquid to the second PVA film to make an infrared dye PVA film; apply the infrared dye PVA film onto a lens substrate.

In yet another aspect of the invention, an infrared dye coated PVA film is disclosed comprising a first PVA film coated by a layer of infrared dye liquid wherein the infrared dye liquid is made by mixing a portion of infrared dye powder with a portion of dissolved PVA film liquid wherein the dissolved PVA film liquid is made by dissolving a second PVA film in water.

In one embodiment, the infrared dye liquid is applied to the second PVA film by dipping the second PVA film into a tank holding the infrared dye liquid. In another embodiment, the infrared dye liquid is applied to the second PVA film by spraying the infrared dye liquid onto the second PVA film. In yet another embodiment, the infrared dye liquid is applied to the second PVA film in room temperature.

In yet another aspect of the invention, a polarized lens is disclosed comprising a lens substrate layered by an infrared dye coated PVA film where the infrared dye coated PVA film is comprised of a first PVA film coated by a layer of infrared dye liquid wherein the infrared dye liquid is made by mixing a portion of infrared dye powder with a portion of dissolved PVA film liquid wherein the dissolved PVA film liquid is made by dissolving a second PVA film in water.

### BRIEF DESCRIPTION OF THE DRAWINGS

The invention is generally shown by way of reference to the accompanying drawings in which:

FIG. 1 illustrates a preparation of the PVA film dissolved in soluble solution.

FIG. 2 illustrates a preparation of the water soluble infrared dye liquid.

FIG. 3 illustrates a process of treating PVA film with infrared dye liquid.

FIG. 4 illustrates an alternative process of treating PVA film with infrared dye liquid.

FIG. 5 illustrates the application of infrared dye absorbed coating layer on a curved surface of a lens

FIG. 6 illustrates a curved lens with an infrared dye absorbed coating layer as applied within the lens.

### DETAIL DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed.

Eyeglasses lenses are made of layers which include an outer, convex hard coating, a layer of hard epoxy, a PVA film, a layer of soft epoxy, a layer of adhesive, a base material, and an inner, concave hard coating, wherein a infrared-blocking layer of infrared dye absorbed coating layer is included. More specifically, the infrared absorbed coating layer blocks wave lengths in the range of 780-2000 nm to provide sunglasses and other lenses with infrared protection.

In one preferred embodiment, a method of making an infrared dye absorbed coating is disclosed to which it comprises the steps wherein the PVA film is dissolved in water, upon which infrared dye is mixed with the said dissolved PVA film, resulting in a water soluble infrared dye liquid. The PVA film dissolved in the water and mixed with the infrared dye allows the PVA film to bond with the infrared dye easily. Next, a PVA film is ran through the infrared dye liquid holding tank via dipping or spraying, among other techniques, the infrared dye liquid onto the PVA film. This allows the infrared dye liquid to be attached to the PVA film quickly and easily.

In other embodiments, the infrared dye absorbed powder can be dissolved in either water-based or solvent-based solution with solid polymers such as acrylic, epoxy, PU, PVA, Polyurethane, etc. Therefore, the present invention of infrared dye absorbed coating methodology is very flexible and adaptive to the needs and the types of material requiring the said infrared coating layer.

The PVA film with infrared dye liquid results in an infrared dye absorbed coating layer that can be applied to lenses. The said coating layer is thinner at about 0.03 mm to 0.06 mm, whereas the traditional methods of application via injection or extrusion result in significantly thicker coating layer. Furthermore, the infrared absorbed coating mixture can be applied on a plane/flat surface or a curved or uneven surface such as on a silk screen or a pad print, as the method of application is accomplished via dipping or spraying, rather than injection or extrusion. Moreover, the IR absorbed coating can be applied on the surface, the backside, or any and every layer of coating, and more IR dye powder can be added to the solvent to block more IR ray.

For example, a PVA film with 80% or more polarization can transmit about 40% to 50% of light. In order to get better transmission, however, IR dye powder is added as to increase the light being emitted by 1% to 20% depending on the quantity of the IR dye absorbed powder, and the viewer can see more clearly because of more light being emitted thus using reducing strain on the eyes.

Most importantly, the present invention corrects the problem of extrusion or injection, both of which are techniques used in safety and welding glasses and require high temperature as high as 250 to 300 degrees Fahrenheit. The required high temperature will damage the molecular structure of the IR dye and reduce the capability of IR to block light. In fact, the required high temperature reduces the transparency of the lenses and causes the lenses to become a little milky or opaque.

Traditionally, multi-layer vacuum coating is used to coat one side or both sides, the coating causes the surface to shine and appear to be a red-gold color. The coating, however, is often uneven and can be easily scratched. On the other hand, the present invention avoids these issues. Additionally, in the present invention, different IR dye absorbed powder can block different wave length and different IR dye absorbed powder can be mixed to block a wider range of wave length, thus allowing more choices of IR absorbed powder with which to use to apply the coating.

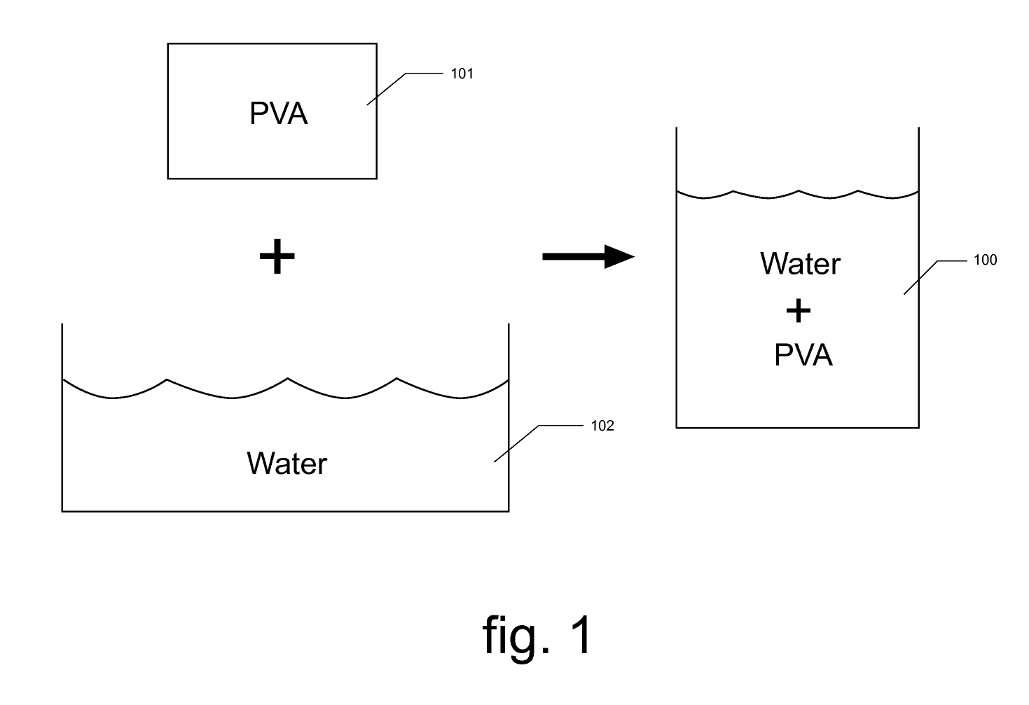

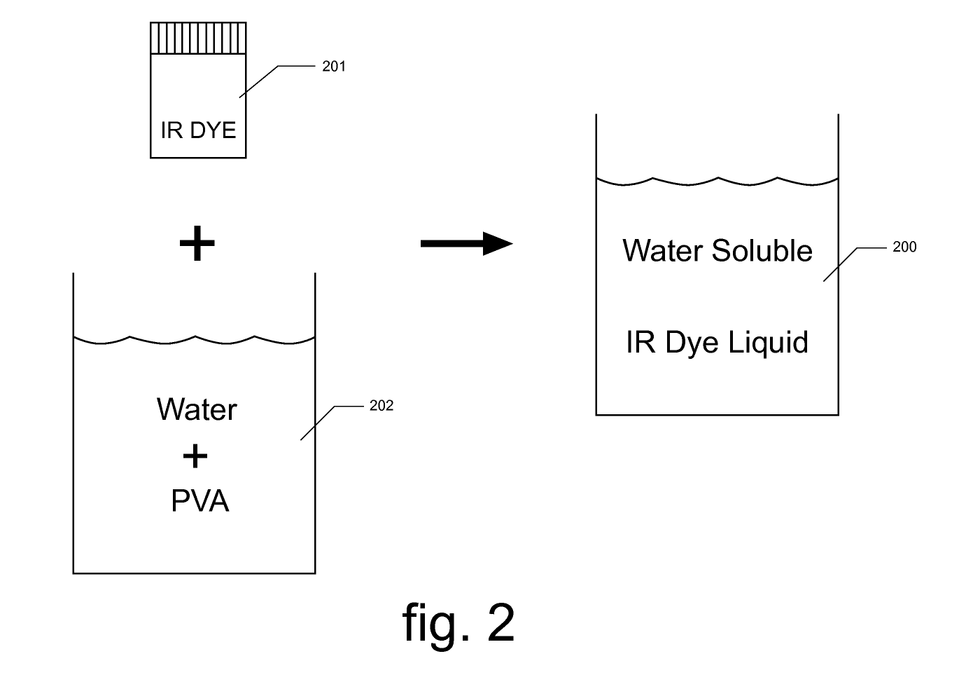

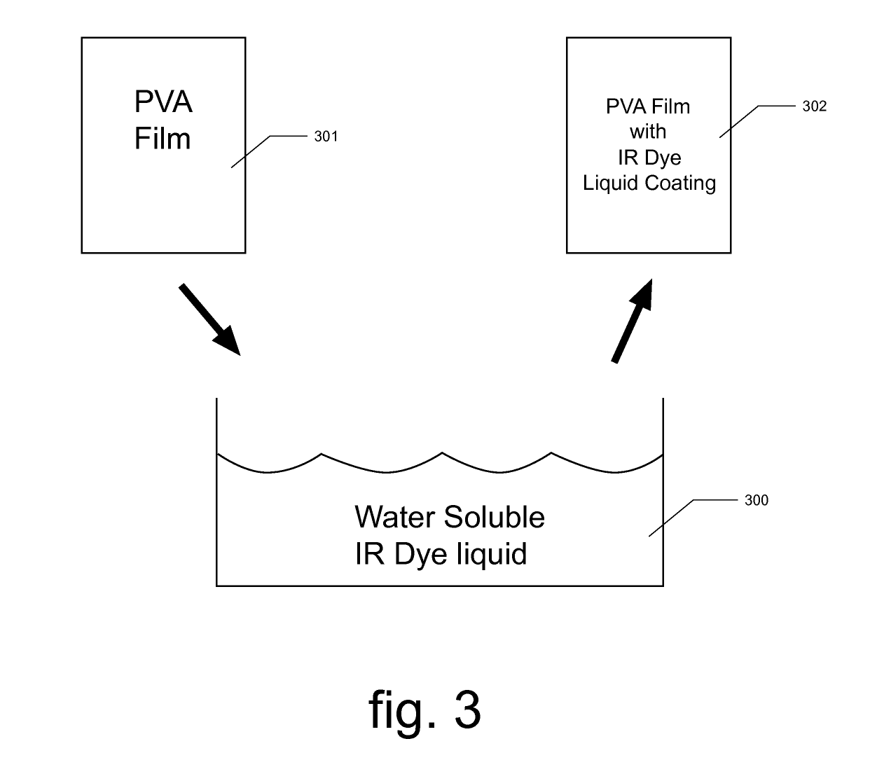

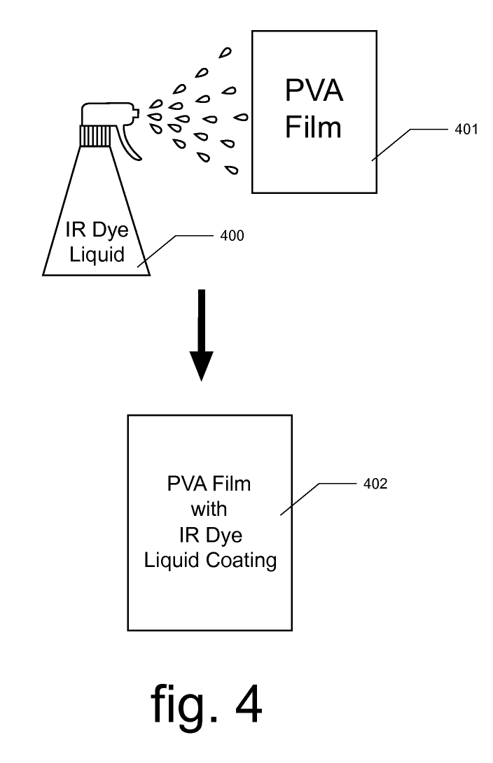

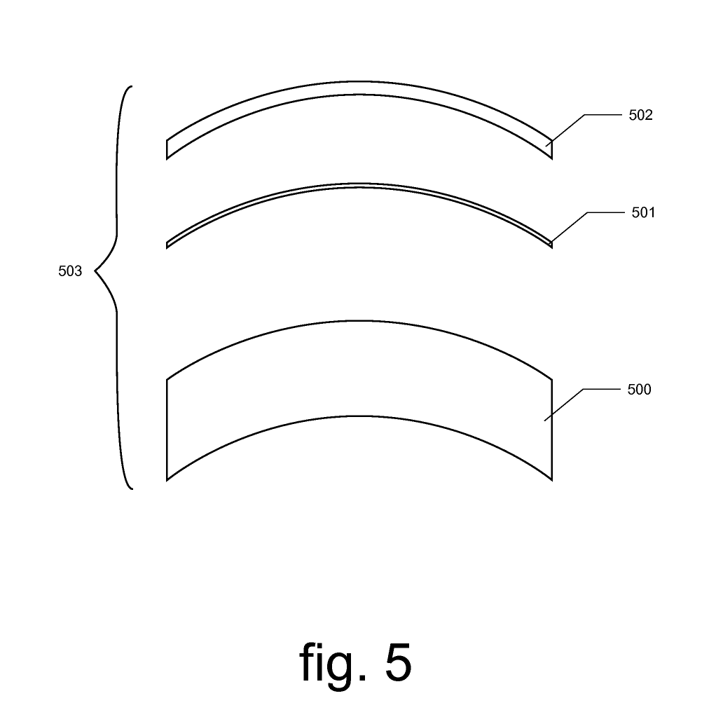

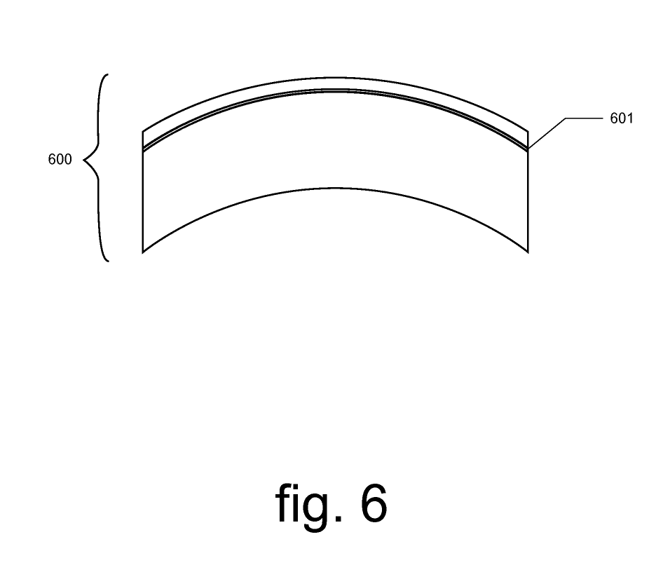

The present invention is an infrared dye absorbed coated lens and a method of making such infrared dye absorbed coated lens. As depicted in FIG. 1, polyvinyl acetate, or PVA, which is a rubbery synthetic polymer, is dissolved in water solution to form a PVA solution. Then, as depicted in FIG. 2, the infrared dye is mixed with the PVA solution to form a water-soluble infrared dye liquid. Next, the water soluble infrared dye liquid is applied to the PVA film. As depicted in FIG. 3, the water-soluble infrared dye liquid solution can be applied by dipping the PVA film into the said solution. Alternatively, as depicted FIG. 4, the application of the infrared dye liquid onto the PVA film can also be accomplished via spraying the infrared dye liquid solution onto the PVA film. Next, the infrared dye liquid solution treated PVA film can be layered onto the desired surfaces. As depicted in FIG. 5, an infrared dye liquid solution treated PVA film is layered onto a curved surface of a lens to form an infrared dye absorbed coating. Finally, FIG. 6 depicts a curved lens with an infrared dye absorbed coating layer within the lens.

### DETAIL DESCRIPTION OF THE DRAWINGS

FIG. 1 illustrates a preparation of the PVA solution 100, wherein the PVA 101 is dissolved into water solution 102.

FIG. 2 illustrates a preparation of the water-soluble infrared dye liquid solution 200, wherein the infrared dye 201 is dissolved into the previously prepared PVA solution 202. More specifically, the infrared dye absorb powder 201 can be dissolved in either water-based solution 202 or solvent-based solution with solid polymers such as acrylic, epoxy, PU, PVA, Polyurethane, etc. to form the infrared dye liquid solution 200.

FIG. 3 illustrates an application of the water soluble infrared dye liquid 300 onto a PVA film 301 to form a PVA film with infrared dye liquid coating 302. More specifically, the PVA film 301 is dipped into an infrared dye liquid 300, wherein infrared dye bonds with the PVA film 301 to form a PVA film with infrared dye liquid coating 302.

FIG. 4 illustrates an alternative application of the water soluble infrared dye liquid 400 onto a PVA film 401 to form a PVA film with infrared dye liquid coating 402. More specifically, the PVA film 401 is sprayed with infrared dye liquid solution 400, wherein the infrared dye bonds with the PVA film 401 to form a PVA film with infrared dye coating 402.

FIG. 5 illustrates an application of a infrared dye absorbed coating layer 501 onto a curved surface of a lens 503, wherein the lens 503 is made up of multiple layers 500, 501, 502, and one of the layers is the infrared dye absorbed coating 501 that is the result of the PVA film with infrared dye liquid coating as depicted in FIG. 3 and FIG. 4.

FIG. 6 illustrates a typical lens 600 comprises of layers including an outer, convex hard coating, a layer of hard epoxy, a PVA film with a infrared dye absorbed coating 601, a layer of hard epoxy, a PVA film, a layer of soft epoxy, a layer of adhesive, a base material and an inner concave hard coating.

1. A method of making infrared dye absorbed PVA film comprising:
a. provide a first PVA film:
b. dissolve said PVA film in a portion of water to make a portion of dissolved PVA film liquid;
c. provide a portion of infrared dye powder;
d. dissolve said portion of infrared dye powder in said portion of PVA film liquid to make a portion of infrared dye liquid;
e. provide a second PVA film;
f. apply said portion of infrared dye liquid to said second PVA film to make an infrared dye PVA film.

2. The method of 1 wherein said infrared dye liquid is applied to said second PVA film by dipping said second PVA film into a tank holding said infrared dye liquid.

3. The method of 1 wherein said infrared dye liquid is applied to said second PVA film by spraying said infrared dye liquid onto said second PVA film.

4. The method of 1 wherein said infrared dye liquid is applied to said second PVA film in room temperature.

5. A method of making polarized lens comprising:
a. provide a first PVA film:
b. dissolve said PVA film in a portion of water to make a portion of dissolved PVA film liquid;
c. provide a portion of infrared dye powder;
d. dissolve said portion of infrared dye powder in said portion of PVA film liquid to make a portion of infrared dye liquid;
e. provide a second PVA film;
f. apply said portion of infrared dye liquid to said second PVA film to make a infrared dye PVA film;
g. apply said infrared dye PVA film onto a lens substrate.

6. The method of 5 wherein said infrared dye liquid is applied to said second PVA film by dipping said second PVA film into a tank holding said infrared dye liquid.

7. The method of 5 wherein said infrared dye liquid is applied to said second PVA film by spraying said infrared dye liquid onto said second PVA film.

8. The method of 5 wherein said infrared dye liquid is applied to said second PVA film in room temperature.

9. An infrared dye coated PVA film comprising a first PVA film coated by a layer of infrared dye liquid wherein said infrared dye liquid is made by mixing a portion of infrared dye powder with a portion of dissolved PVA film liquid wherein said dissolved PVA film liquid is made by dissolving a second PVA film in water.

10. The PVA film of claim 9 wherein said infrared dye liquid is coated to said first PVA film by dipping said first PVA film into a tank holding said infrared dye liquid.

11. The PVA film of claim 9 wherein said infrared dye liquid is coated to said first PVA film by spraying said infrared dye liquid onto said first PVA film.

12. The PVA film of claim 9 wherein said infrared dye liquid is applied to said first PVA film in room temperature.

13. A polarized lens comprising a lens substrate layered by an infrared dye coated PVA film where said infrared dye coated PVA film is comprised of a first PVA film coated by a layer of infrared dye liquid wherein said infrared dye liquid is made by mixing a portion of infrared dye powder with a portion of dissolved PVA film liquid wherein said dissolved PVA film liquid is made by dissolving a second PVA film in water.

14. The polarized lens of claim 13 wherein said infrared dye liquid is coated to said first PVA film by dipping said first PVA film into a tank holding said infrared dye liquid.

15. The polarized lens of claim 13 wherein said infrared dye liquid is coated to said first PVA film by spraying said infrared dye liquid onto said first PVA film.

16. The polarized lens of claim 13 wherein said infrared dye liquid is applied to said first PVA film in room temperature.
